(19) United States
(12) Patent Application Publication
(10) Pub. No.: US 2022/0044676 A1
(43) Pub. Date: Feb. 10, 2022

(54) DETERMINATION OF USER INTENT USING CONTEXTUAL ANALYSIS

(71) Applicant: Bank of America Corporation, Charlotte, NC (US)

(72) Inventor: Emad Noorizadeh, Plano, TX (US)

(21) Appl. No.: 16/984,450

(22) Filed: Aug. 4, 2020

(51) Int. Cl. G10L 15/18; G10L 15/22

(52) U.S. Cl. CPC G10L 15/1815; G10L 15/22

(57) ABSTRACT

Systems and method for predicting user intent using contextual analysis are provided. The systems and method may include contextual conversation assistant receiving a conversation input from a user wherein the user's intent is prima facie ambiguous, comparing the conversation input with historical data with known meaning, performing a self-referential internal contextual analysis on the ambiguous conversation input, and generating a conversation output determining the user's intent based on the contextual analysis. The self-referential internal contextual analysis may include comparing each word of the ambiguous conversation input with a portion of or all remaining words of the conversation input.

### FIELD OF TECHNOLOGY

This disclosure relates to predicting and determining user intent using contextual analysis.

### BACKGROUND

Millions of times a day, customers or users place a telephonic call to a business or type a message in a messaging application and reach an automated and computerized answering service instead of a person. Often, the answering service computer requests the user describe the issue they are having so that the answering service may assist. Many times, the description provided by the user is ambiguous.

Various conventional approaches exist to respond to such ambiguity. These approaches include comparison with historical data, guesswork, and requesting the user rephrase the issue. However, these approaches may not be accurate and may discourage or frustrate the user.

As a result, it would be desirable to provide systems and methods that more accurately predict and determine the user's intent.

### SUMMARY OF THE DISCLOSURE

It is an object of this disclosure to provide systems and methods that more accurately predict and determine the user's intent.

A computerized contextual conversation assistant is provided. The conversation assistant involves a conversation input from a user/customer. The conversation input may include one or more phrases, with each phrase being at least two words. The conversation assistant may then analyze the conversation input through a comparison with historical data. When the comparison with historical data is insufficient to determine the user's intent in the conversation input to a threshold level of more likely than not (i.e., the conversation input remains ambiguous), the conversation assistant may then perform a self-referential contextual internal analysis of each word of each phrase to determine the user's intent. The contextual analysis may include a comparison of each word of the ambiguous phrase with an adjacent word of the phrase. The contextual analysis may also include a comparison of each phrase with some or all other phrases. A comparison may include, but is not limited to, the meaning of each word, the tone (if known) of each word, any emphasis (e.g., italics, underline, volume, CAPITALS) supplied by the user, any punctuation, and distance between various words. Once the conversation assistant obtains the comparison data, it analyzes the data to determine the user's intent. The comparison data may be analyzed to confirm knowledge of user intent to a pre-determined threshold level. For example, the user's intent is more likely than not to be X, Y, or Z. The analysis may include a scoring rubric for each point of comparison (e.g., the meaning of the words may be scored higher and carry more weight in the analysis than the punctuation). Once the conversation assistant performs this contextual analysis, it may provide a conversation output based, at least in part, on the contextual analysis it performed and provide a determination of the user's intent in the conversation input.

A conversation input may be considered prima facie ambiguous when the conversation assistant is more likely than not to be unable to determine the user's intent. A conversation input may be considered prima facie unambiguous when the conversation assistant is more likely than not to be able to determine the user's intent.

In some embodiments, the historical data may include conversation inputs from different users. In other embodiments, the historical data may include prior conversation inputs from the same user, including earlier conversation inputs and phrases from the currently-analyzed conversation. Historical data may also include any responses provided by a conversation assistant in the currently-analyzed conversation or prior conversations, as well as any user replies to the responses.

In some embodiments, the contextual analysis may be iterated until the contextual analysis clarifies the ambiguity or ambiguities and the conversation assistant has determined the user's intent to a pre-determined threshold level of more likely than not.

In some embodiments, the contextual analysis may include a comparison of each word within the phrase with both a preceding word and a subsequent word.

In other embodiments, the contextual analysis may include a comparison of each word within the phrase with a random sampling of the entire conversation input.

In some embodiments, the conversation input may include at least two separate phrases of at least two words each, with one phrase being unambiguous with respect to the user's intent and the other phrase(s) being ambiguous with respect to the user's intent. In this situation, the contextual analysis may include a comparison of each word of the ambiguous phrase(s) with all or a portion of the unambiguous phrase or a comparison of the entire ambiguous phrase with the unambiguous phrase.

### BRIEF DESCRIPTION OF THE DRAWINGS

The objects and advantages of the invention will be apparent upon consideration of the following detailed description, taken in conjunction with the accompanying drawings, in which like reference characters refer to like parts throughout, and in which:

FIG. 1 is an illustrative flowchart of a contextual conversation assistant in accordance with the principles of the disclosure;

FIG. 2 is an illustrative flowchart of a process by which a contextual conversation assistant may determine meaning through context in accordance with the principles of the disclosure;

FIG. 3 is an illustrative flowchart of a contextual conversation assistant's internal contextual analysis in accordance with the principles of the disclosure;

FIG. 4 is another illustrative flowchart of a contextual conversation assistant's internal contextual analysis in accordance with the principles of the disclosure;

FIG. 5 is yet another illustrative flowchart of a contextual conversation assistant's internal contextual analysis in accordance with the principles of the disclosure;

FIG. 6 is still another illustrative flowchart of a contextual conversation assistant's internal contextual analysis in accordance with the principles of the disclosure;

FIG. 7 is another illustrative flowchart of a contextual conversation assistant in accordance with the principles of the disclosure; and

FIG. 8 is yet another illustrative flowchart of a contextual conversation assistant in accordance with the principles of the disclosure.

### DETAILED DESCRIPTION

A computerized contextual conversation assistant is provided. The conversation assistant requires a conversation input from a user/customer. The conversation input may include one or more phrases, with each phrase being at least two words. The longer the conversation input is, the more likely it will be that the conversation assistant may be able to determine the user's intent. The conversation input may be in the form of audio, audiovisual, or text. If the conversation input is in an audio or audiovisual format, the contextual conversation assistant may need to have the ability to transform the conversation input into a machine-readable format, such as text.

The conversation assistant may then analyze the conversation input through a comparison with historical data. In some embodiments, the historical data may include conversation inputs from different users. In other embodiments, the historical data may include prior conversation inputs from the same user, including earlier conversation inputs and phrases from the currently analyzed conversation. In yet other embodiments, the historical data may include conversation inputs from both the same user and other users. Historical data may also include any responses provided by a conversation assistant in the currently-analyzed conversation or prior conversations, as well as any user replies to the responses.

A comparison may include, but is not limited to, the meaning of each word, the tone (if known) of each word, any emphasis (e.g., italics, underline, volume, CAPITALS) supplied by the user, any punctuation, size of the phrase(s), and distance between various words. In an embodiment, once the conversation assistant obtains the comparison data, it analyzes the data to determine the user's intent. The comparison data may be analyzed to confirm knowledge of user intent to a pre-determined threshold level. For example, the user's intent is more likely than not to be X, Y, and/or Z. The analysis may include a scoring rubric for each point of comparison. For example, in the scoring rubric the meaning of the words may be scored higher and carry more weight in the analysis than the punctuation.

When the comparison with historical data is insufficient to determine the user's intent in the conversation input (i.e., the conversation input remains prima facie ambiguous), the conversation assistant may then perform a self-referential contextual internal analysis of each word of each phrase to determine the user's intent. (A conversation input may be considered prima facie ambiguous when the conversation assistant is more likely than not to be unable to determine the user's intent. A conversation input may be considered prima facie unambiguous when the conversation assistant is more likely than not to be able to determine the user's intent.) The contextual analysis may include a comparison of each word of the ambiguous phrase with an adjacent word of the phrase. Once the conversation assistant performs this self-referential contextual internal analysis, it may provide a conversation output based, at least in part, on the contextual analysis it performed and provide a determination of the user's intent in the conversation input.

In some embodiments, the conversation output may include a request to the user to confirm the conversation assistant's determination of user intent. For example, if the conversation assistant determines that the user intent is “A”, it may ask the user to confirm that what the user meant is “A”. If the user denies that he meant “A”, the conversation assistant may iterate and perform another self-referential contextual internal analysis where the determination of user intent cannot be “A”.

In some embodiments, the contextual analysis may be iterated until the contextual analysis clarifies the ambiguity or ambiguities and the conversation assistant has determined the user's intent to a pre-determined threshold level of more likely than not (i.e., 51% accuracy of the user's intent).

In some embodiments, the contextual analysis may include a comparison of each word within the phrase with both a preceding word and a subsequent word.

In other embodiments, the contextual analysis may include a comparison of each word within the phrase with a random sampling of the entire conversation input.

In some embodiments, the conversation input may include at least two separate phrases of at least two words each, with one phrase being unambiguous with respect to the user's intent and the other phrase(s) being ambiguous with respect to the user's intent. In this situation, the contextual analysis may include a comparison of each word of the ambiguous phrase(s) with all or a portion of the unambiguous phrase.

In some embodiments, the contextual conversation assistant may include one or more machine learning algorithms to improve the accuracy of its determinations of user intent over time. The machine learning algorithms may be able to be trained with example conversation inputs whose meanings are known to an outside observer. In an embodiment, the outside observer will provide at least one example conversation input to the contextual conversation assistant. The contextual conversation assistant may then analyze the conversation input as described in this disclosure. The outside observer may inform the contextual conversation assistant if it correctly determined user intent, or not. The conversation assistant may then use that knowledge to learn from its mistakes and successes, and improve its accuracy.

A method for determining user intent in an ambiguous phrase according to the embodiments is provided. The method may include a computer comprising a contextual conversation assistant receiving a conversation input from the user. The conversation input must include at least one distinct phrase including at least two words. If the contextual conversation assistant determines the conversation input is ambiguous and cannot determine the user's intent, the conversation assistant may then analyze the conversation input by comparing it with historical data stored in the computer's memory or accessible by the conversation assistant. The historical data should have known meaning(s) to effectuate the comparison. If the conversation input remains prima facie ambiguous after a comparison with historical data, the contextual conversation assistant may then attempt to determine context of the conversation input (i.e., remove any ambiguity and determine the user's intent) by comparing each word of each phrase with all remaining words of the conversation input. Once the conversation assistant performs this contextual analysis determination, it may provide a conversation output based, at least in part, on the contextual analysis it performed and provide a determination of the user's intent in the conversation input.

The conversation input may be in a text, audio, or audiovisual format, or any combination thereof. If the conversation input is audio or audiovisual, an ability to transform the audio into a computer machine-readable format may be necessary.

In some embodiments, if the conversation input is audio or audiovisual, the contextual conversation assistant may analyze, at least, the conversation input's tone, intonation, repetition, connotation, denotation, inflection, emphasis, cadence, pitch, and volume, to determine the context of the conversation input (i.e., remove any ambiguity and determine the user's intent). For example, a rising volume may indicate the user's frustration and/or anger. This knowledge may assist the contextual conversation assistant to determine context of the conversation input (i.e., remove any ambiguity and determine the user's intent).

In some embodiments, if the conversation input is audiovisual, the contextual conversation assistant may analyze, inter alia, the visual cues provided by the user, such as body language, a flushed face, hand gestures, or facial expressions, to help determine the context of the conversation input (i.e., remove any ambiguity and determine the user's intent). For example, a flushed face may indicate anger and/or frustration, which may assist the contextual conversation assistant in determining the context of the conversation input (i.e., remove any ambiguity and determine the user's intent).

In some embodiments, if the conversation input is text, the contextual conversation assistant may analyze and measure the conversation input's speed, punctuation and grammar to determine context of the conversation input (i.e., remove any ambiguity and determine the user's intent). For example, a conversation input in ALL CAPITAL letters may indicate user anger and/or frustration. A surplus of punctuation, for example, multiple exclamation points, may indicate a word or phrase the user wants to emphasize. This knowledge may assist the contextual conversation assistant in determining context of the conversation input (i.e., remove any ambiguity and determine the user's intent).

In some embodiments, the historical data may include conversation inputs from different users. In other embodiments, the historical data may include prior conversation inputs from the same user, including earlier conversation inputs and phrases from the currently analyzed conversation. Historical data may also include any responses provided by a conversation assistant in the currently-analyzed conversation or prior conversations, as well as any user replies to the responses. The historical data should have a meaning(s) known to the contextual conversation assistant.

In some embodiments, the contextual conversation assistant may determine the context of the phrase (i.e., remove an ambiguity and determine the user's intent) by comparing each word of the phrase with a subsequent word.

In other embodiments, the contextual conversation assistant may determine the context of the phrase (i.e., remove an ambiguity and determine the user's intent) by comparing each word of the phrase with a preceding word.

In other embodiments, the contextual conversation assistant may determine the context of the phrase (i.e., remove an ambiguity and determine the user's intent) by comparing each word of the phrase with both a subsequent word and a preceding word.

In other embodiments, the contextual conversation assistant may determine the context of the phrase (i.e., remove an ambiguity and determine the user's intent) by comparing each word of the phrase with a random sampling of the conversation input.

In other embodiments, the contextual conversation assistant may determine the context of the phrase (i.e., remove an ambiguity and determine the user's intent) by doing two or more of the above comparisons simultaneously or successively.

Depending on the degree of ambiguity in the conversation input, it may be necessary for the contextual conversation assistant to determine the context of the phrase (i.e., remove an ambiguity and determine the user's intent) by iterating each contextual comparison until the user's intent has been determined.

Each contextual comparison may include, but is not limited to, the meaning of each word, the tone (if known) of each word, any emphasis (e.g., italics, underline, volume, CAPITALS) supplied by the user, any punctuation, size of the phrase(s), and distance between various words. In an embodiment, once the conversation assistant obtains the comparison data, it analyzes the data to determine the user's intent. The comparison data may be analyzed to confirm knowledge of user intent to a pre-determined threshold level. For example, the user's intent is more likely than not to be X, Y, and/or Z. The analysis may include a scoring rubric for each point of comparison. For example, in the scoring rubric the meaning of the words may be scored higher and carry more weight in the analysis than the punctuation. The scoring rubric may be adjusted from time to time by the conversation assistant or an outside observer. The scoring rubric may also be adjusted by a machine-learning algorithm. For example, if a machine-learning algorithm discovers that a user's intent can be determined more easily by giving more weight to punctuation than the distance between words, the scoring rubric may be adjusted to accommodate that discovery.

After the contextual conversation assistant has determined the context of the ambiguous phrase (i.e., removed the ambiguity and determined the user's intent), it may generate a conversation output reflecting the user's determined intent according to its programmed instructions. For example, if the contextual conversation assistant has determined that the user intended to request an account balance or current due amount, the contextual conversation assistant may, if programmed instructions permit such an action, provide the requested account balance or current due amount. Other conversation outputs may include, but are not limited to, transferring the user to an in-person customer support representative, refusing to divulge the requested information for security or confidentiality reasons, logging the user's intent and placing the user in a queue for final determination, and simply following the user's intent as much as practicable.

In some embodiments, the conversation output may be presented to the user in a text format. In other embodiments, the conversation output may be presented to the user in an audio or audiovisual format. It may be preferable for the contextual conversation assistant to mirror the format of the conversation input when presenting the conversation output, i.e., if the conversation input was in a text format, the conversation output should also be in a text format.

In some embodiments, if the contextual conversation assistant cannot determine the user's intent after performing a contextual analysis, the conversation assistant may generate a conversation output requesting more information and/or a new conversation input from the user, e.g. a request to the user to restate the conversation input in different words.

The contextual conversation assistant may be adapted to perform in any language, and in some embodiments, a translation ability may be added to the contextual conversation assistant.

In some embodiments, the conversation input may include at least two phrases of at least two words each, with the user intent behind one phrase being prima fade unambiguous and the user intent behind the other phrase(s) being prima fade ambiguous. In this situation, the contextual conversation assistant may analyze the ambiguous phrase by comparing each word of the phrase with all or a portion of the unambiguous phrase, by itself or in addition to the other comparisons and analysis described above.

Other systems and methods for determining user intent may include a contextual conversation assistant that does not utilize historical data. The conversation assistant involves a conversation input from a user/customer. The conversation input may include one or more phrases, with each phrase being at least two words. An intention of the conversation input may be prima facie ambiguous. When the user's intent in the conversation input is prima facie ambiguous, the conversation assistant may then perform a self-referential contextual internal analysis of each word of each phrase to determine the user's intent. The contextual analysis may include a comparison of each word of the ambiguous phrase with all remaining words of the conversation input as well as a comparison with an adjacent word of the phrase. Once the conversation assistant performs this contextual analysis, it may provide a conversation output based, at least in part, on the contextual analysis it performed and provide a determination of the user's intent in the conversation input.

In some embodiments, the contextual analysis may include some or all of the contextual analyses described above, such as (but not limited to), comparing the conversation input with an adjacent word or words of the phrase or comparing the conversation input with a random sampling of the conversation input.

Depending on the degree of ambiguity in the conversation input, it may be necessary for the contextual conversation assistant to determine the context of the phrase (i.e., remove an ambiguity and determine the user's intent) by iterating each contextual comparison until the user's intent has been determined.

Illustrative embodiments of apparatus and methods in accordance with the principles of the invention will now be described with reference to the accompanying drawings, which form a part hereof. It is to be understood that other embodiments may be utilized and structural, functional and procedural modifications may be made without departing from the scope and spirit of the present invention.

The drawings show illustrative features of apparatus and methods in accordance with the principles of the invention. The features are illustrated in the context of selected embodiments. It will be understood that features shown in connection with one of the embodiments may be practiced in accordance with the principles of the invention along with features shown in connection with another of the embodiments.

Apparatus and methods described herein are illustrative. Apparatus and methods of the invention may involve some or all of the features of the illustrative apparatus and/or some or all of the steps of the illustrative methods. The steps of the methods may be performed in an order other than the order shown or described herein. Some embodiments may omit steps shown or described in connection with the illustrative methods. Some embodiments may include steps that are not shown or described in connection with the illustrative methods, but rather shown or described in a different portion of the specification.

One of ordinary skill in the art will appreciate that the steps shown and described herein may be performed in other than the recited order and that one or more steps illustrated may be optional. The methods of the above-referenced embodiments may involve the use of any suitable elements, steps, computer-executable instructions, or computer-readable data structures. In this regard, other embodiments are disclosed herein as well that can be partially or wholly implemented on a computer-readable medium, for example, by storing computer-executable instructions or modules or by utilizing computer-readable data structures.

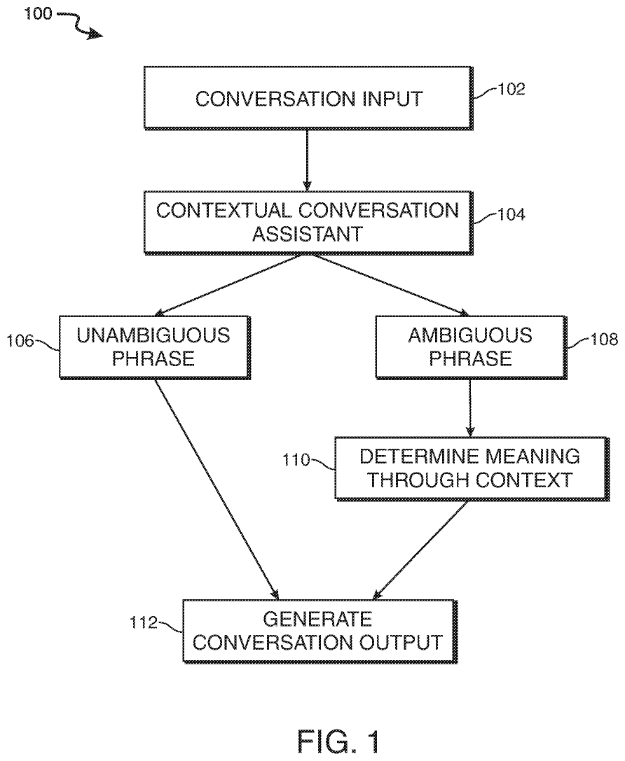

FIG. 1 is an illustrative flowchart of a contextual conversation assistant process 100 in accordance with the principles of the disclosure. The process 100 begins with a conversation input 102 from a user which is provided to a contextual conversation assistant 104. The conversation input 102 may include one or more phrases, with each phrase being at least two words. The contextual conversation assistant 104 will determine if the user's intent in each phrase is prima facie ambiguous 108 or prima facie unambiguous 106. If a phrase is unambiguous 106, the contextual conversation assistant may generate a conversation output 112 based, at least in part, on its determination of the user's intent of the unambiguous phrase. If the user's intent behind a phrase is ambiguous 108, the contextual conversation assistant 104 may attempt to determine the meaning (i.e., the user's intent) behind the phrase through a contextual analysis 110. After the contextual conversation assistant 104 has determined the meaning of the ambiguous phrase 108, it may generate a conversation output 112 based, at least in part, on its determination of the user's intent.

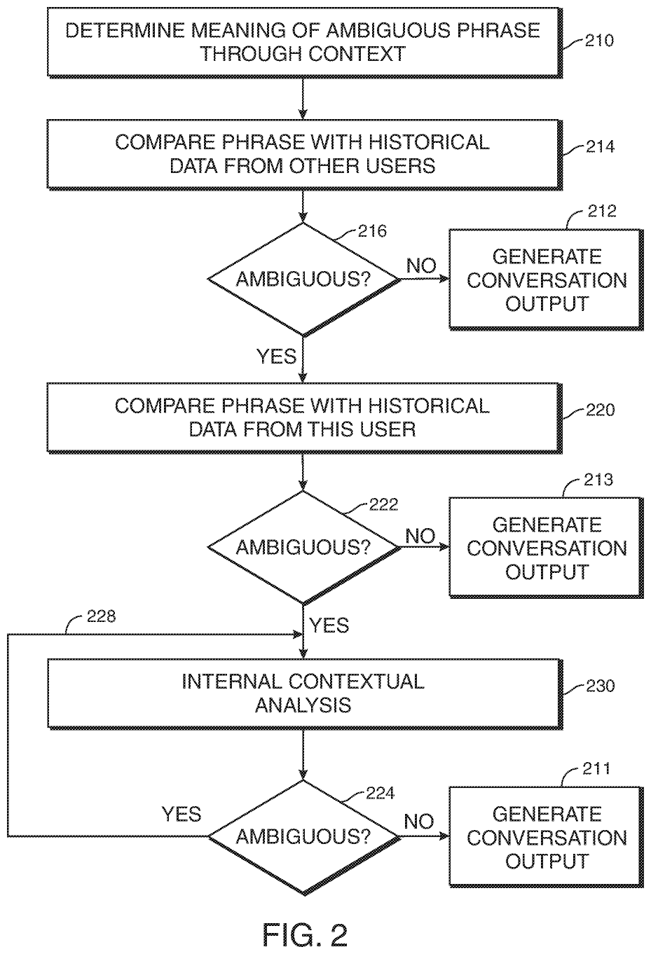

FIG. 2 is an illustrative flowchart of a process by which a contextual conversation assistant may determine meaning of a phrase through context 210 in accordance with the principles of the disclosure. This figure shows a process that begins with step 210, determining meaning of an ambiguous phrase through context. Step 210 may have characteristics corresponding to 110 (shown in FIG. 1). FIG. 2 shows a possible embodiment of an expansion of step 110 shown in FIG. 1. In a possible embodiment, to determine the meaning (i.e., user intent) of an ambiguous phrase through a contextual analysis 210, the first step may be to compare the ambiguous phrase with historical data from other users 214. Then the contextual conversation assistant will determine if the phrase is still ambiguous 216. If it is no longer ambiguous, the contextual conversation assistant may generate a conversation output 212 based on its analysis in step 214. If the phrase remains prima fade ambiguous, a next step 220 may be to compare the phrase with historical data from the user who provided the ambiguous phrase. Then the contextual conversation assistant will determine if the phrase is still ambiguous 222. If it is no longer ambiguous, the contextual conversation assistant may generate a conversation output 213 based on its analysis in step 220. If the phrase remains prima facie ambiguous, a next step 230 may be to perform a self-referential internal contextual analysis of the phrase. Then the contextual conversation assistant will determine if the phrase is still ambiguous 224. If it is no longer ambiguous, the contextual conversation assistant may generate a conversation output 211 based on its analysis in step 230. If the phrase remains prima facie ambiguous, step 230 may be iterated 228 until the phrase is no longer ambiguous.

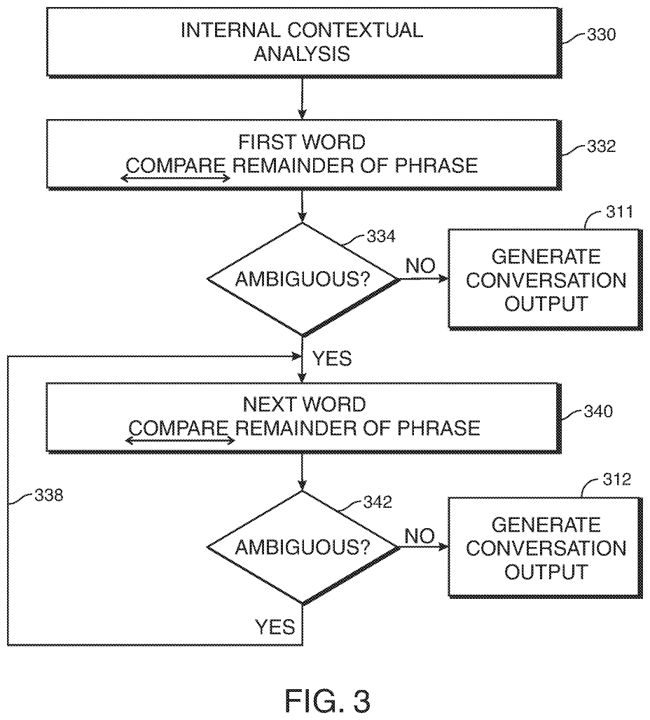

FIG. 3 is illustrative flowchart of a contextual conversation assistant's internal contextual analysis 330 in accordance with the principles of the disclosure. The internal contextual analysis 330 may have characteristics corresponding to 230 (shown in FIG. 2) and FIG. 3 shows a possible embodiment of an expansion of step 230 shown in FIG. 2. In a possible embodiment, this figure shows a process of a self-referential internal contextual analysis 330 that begins with step 332, comparing the first word of an ambiguous phrase with the remainder of the phrase to determine the context (i.e., remove any ambiguity and determine the user's intent) of the ambiguous phrase. Then the contextual conversation assistant will determine if the phrase is still ambiguous 334. If it is no longer ambiguous, the contextual conversation assistant may generate a conversation output 311 based on its analysis in step 332. If the phrase remains prima facie ambiguous, a next step 340 may be to compare the next word of the ambiguous phrase with the remainder of the phrase. Then the contextual conversation assistant will determine if the phrase is still ambiguous 342. If it is no longer ambiguous, the contextual conversation assistant may generate a conversation output 312 based on its analysis in step 340. If the phrase remains prima facie ambiguous, step 340 may be iterated 338 until the phrase is no longer ambiguous.

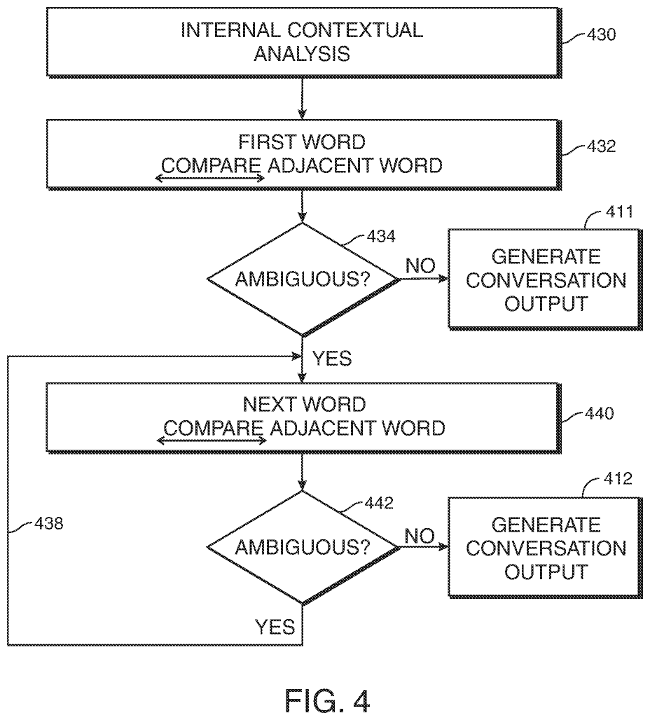

FIG. 4 is another illustrative flowchart of a contextual conversation assistant's internal contextual analysis 430 in accordance with the principles of the disclosure. The internal contextual analysis 430 may have characteristics corresponding to 230 (shown in FIG. 2) and FIG. 4 shows a possible embodiment of an expansion of step 230 shown in FIG. 2. In a possible embodiment, this figure shows a process of a self-referential internal contextual analysis 430 that begins with step 432, comparing the first word of an ambiguous phrase with an adjacent word (i.e., the next word) to determine the context (i.e., remove any ambiguity and determine the user's intent) of the ambiguous phrase. Then the contextual conversation assistant will determine if the phrase is still ambiguous 434. If it is no longer ambiguous, the contextual conversation assistant may generate a conversation output 411 based on its analysis in step 432. If the phrase remains prima facie ambiguous, a next step 440 may be to compare the next word of the ambiguous phrase with an adjacent word of the phrase (i.e., either a prior or subsequent word). Then the contextual conversation assistant will determine if the phrase is still ambiguous 442. If it is no longer ambiguous, the contextual conversation assistant may generate a conversation output 412 based on its analysis in step 440. If the phrase remains prima facie ambiguous, step 440 may be iterated 438 until the phrase is no longer ambiguous.

FIG. 4 is similar to FIG. 3 in that steps and elements 430, 434, 411, 438, 442, and 412 correspond to like elements in FIG. 3. In contrast to FIG. 3, steps 432 and 440 in FIG. 4 illustrate alternative embodiments of an analysis that a contextual conversation assistant may perform.

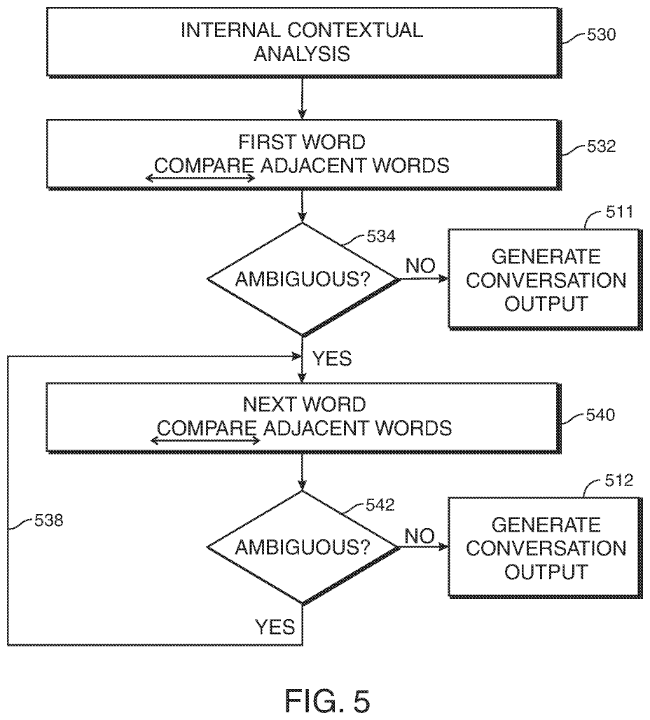

FIG. 5 is another illustrative flowchart of a contextual conversation assistant's internal contextual analysis 530 in accordance with the principles of the disclosure. The internal contextual analysis 530 may have characteristics corresponding to 230 (shown in FIG. 2) and FIG. 5 shows a possible embodiment of an expansion of step 230 shown in FIG. 2. In a possible embodiment, this figure shows a process of a self-referential internal contextual analysis 530 that begins with step 532, comparing the first word of an ambiguous phrase with multiple adjacent words (i.e., the next words of the phrase) to determine the context (i.e., remove any ambiguity and determine the user's intent) of the ambiguous phrase. Then the contextual conversation assistant will determine if the phrase is still ambiguous 534. If it is no longer ambiguous, the contextual conversation assistant may generate a conversation output 511 based on its analysis in step 532. If the phrase remains prima facie ambiguous, a next step 540 may be to compare the next word of the ambiguous phrase with adjacent words of the phrase (e.g. both a prior and subsequent word of the phrase). Then the contextual conversation assistant will determine if the phrase is still ambiguous 542. If it is no longer ambiguous, the contextual conversation assistant may generate a conversation output 512 based on its analysis in step 540. If the phrase remains prima facie ambiguous, step 540 may be iterated 538 until the phrase is no longer ambiguous.

FIG. 5 is similar to FIG. 3 and FIG. 4 in that steps and elements 530, 534, 511, 538, 542, and 512 correspond to like elements in FIG. 3 and FIG. 4. In contrast to FIG. 3 and FIG. 4, steps 532 and 540 in FIG. 5 illustrate alternative embodiments of an analysis that a contextual conversation assistant may perform.

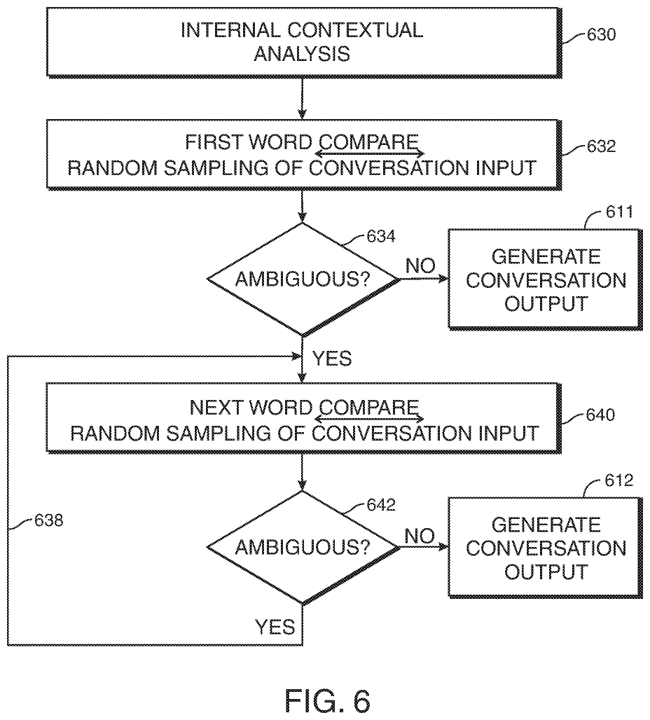

FIG. 6 is another illustrative flowchart of a contextual conversation assistant's internal contextual analysis 630 in accordance with the principles of the disclosure. The internal contextual analysis 630 may have characteristics corresponding to 230 (shown in FIG. 2) and FIG. 6 shows a possible embodiment of an expansion of step 230 shown in FIG. 2. In a possible embodiment, this figure shows a process of a self-referential internal contextual analysis 630 that begins with step 632, comparing the first word of an ambiguous phrase with a random sampling of the entire conversation input from the user to determine the context (i.e., remove any ambiguity and determine the user's intent) of the ambiguous phrase. Then the contextual conversation assistant will determine if the phrase is still ambiguous 634. If it is no longer ambiguous, the contextual conversation assistant may generate a conversation output 611 based on its analysis in step 632. If the phrase remains prima facie ambiguous, a next step 640 may be to compare the next word of the ambiguous phrase with another random sampling of the entire conversation input from the user. The random sampling may be the same as in step 632 or it may be different. Then the contextual conversation assistant will determine if the phrase is still ambiguous 642. If it is no longer ambiguous, the contextual conversation assistant may generate a conversation output 612 based on its analysis in step 640. If the phrase remains prima facie ambiguous, step 640 may be iterated 638 until the phrase is no longer ambiguous.

FIG. 6 is similar to FIG. 3, FIG. 4, and FIG. 5 in that steps and elements 630, 634, 611, 638, 642, and 612 correspond to like elements in FIG. 3, FIG. 4, and FIG. 5. In contrast to FIG. 3, FIG. 4, and FIG. 5, steps 632 and 640 in FIG. 6 illustrate alternative embodiments of an analysis that a contextual conversation assistant may perform.

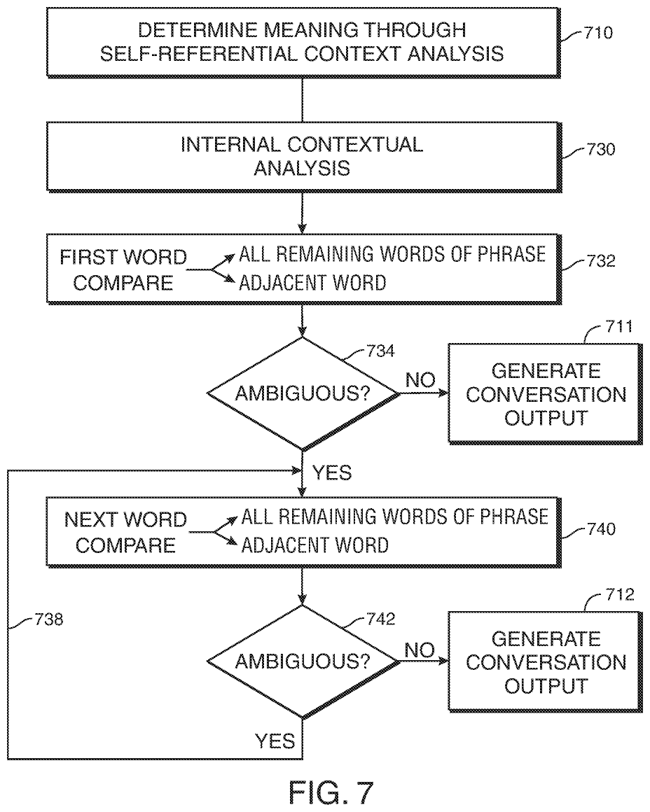

FIG. 7 is an illustrative flowchart of a process by which a contextual conversation assistant may determine meaning of a phrase through context 710 in accordance with the principles of the disclosure. This figure shows a process that begins with step 710, determining meaning of an ambiguous phrase through context. Step 710 may have characteristics corresponding to 110 (shown in FIG. 1). FIG. 7 shows a possible embodiment of an expansion of step 110 shown in FIG. 1. In a possible embodiment, this figure shows a process of a self-referential internal contextual analysis 730 that begins with step 732, comparing the first word of an ambiguous phrase with both an adjacent word and all remaining words of the phrase to determine the context (i.e., remove any ambiguity and determine the user's intent) of the ambiguous phrase. No historical analysis is performed in this possible embodiment as the contextual conversation assistant solely performs a bootstrapping interpretation to determine the user's intent through self-referential internal context analysis. Then the contextual conversation assistant will determine if the phrase is still ambiguous 734. If it is no longer ambiguous, the contextual conversation assistant may generate a conversation output 711 based on its analysis in step 732. If the phrase remains prima facie ambiguous, a next step 740 may be to compare the next word of the ambiguous phrase with both an adjacent word and all remaining words of the phrase to determine the context (i.e., remove any ambiguity and determine the user's intent) of the ambiguous phrase. The adjacent word (or words) may precede or succeed the word of the phrase being compared by the contextual conversation assistant. Then the contextual conversation assistant will determine if the phrase is still ambiguous 742. If it is no longer ambiguous, the contextual conversation assistant may generate a conversation output 712 based on its analysis in step 740. If the phrase remains prima facie ambiguous, step 740 may be iterated 738 until the phrase is no longer ambiguous.

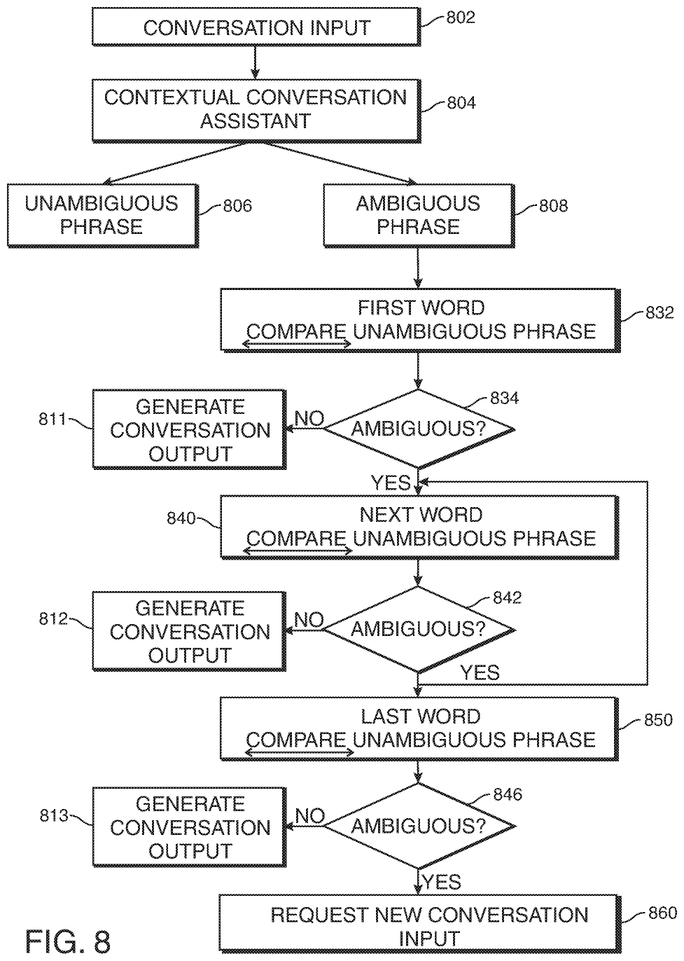

FIG. 8 is another illustrative flowchart of a contextual conversation assistant in accordance with the principles of the disclosure. A conversation input 802 from a user is provided to a contextual conversation assistant 804. In this embodiment, the conversation input 802 must contain at least two phrases of at least two words each, with the user's intent of at least one phrase being prima fade unambiguous, and the user's intent of at least one phrase being prima fade ambiguous. The contextual conversation assistant 804 may analyze the ambiguous phrase 808 by comparing 832 the first word of the ambiguous phrase 808 with the unambiguous phrase 806 to determine the context (i.e., remove any ambiguity and determine the user's intent) of the ambiguous phrase 808. No historical analysis is performed in this possible embodiment, although a historical analysis may be performed in other embodiments. Then the contextual conversation assistant 804 will determine if the phrase is still ambiguous 834. If it is no longer ambiguous, the contextual conversation assistant may generate a conversation output 811 based on its analysis in step 832. If the phrase remains prima facie ambiguous, a next step 840 may be to compare the next word of the ambiguous phrase 808 with the unambiguous phrase 806 to determine the context (i.e., remove any ambiguity and determine the user's intent) of the ambiguous phrase 808. Then the contextual conversation assistant 804 will determine if the phrase is still ambiguous 842. If it is no longer ambiguous, the contextual conversation assistant 804 may generate a conversation output 812 based on its analysis in step 840. If the phrase 808 remains prima facie ambiguous, step 840 may be iterated 838 until the phrase is no longer ambiguous. If the phrase 808 remains prima facie ambiguous after iteration 838 of every word in the phrase except the last word, the next step 850 may be to compare the last word of the ambiguous phrase 808 with the unambiguous phrase 806 to determine the context (i.e., remove any ambiguity and determine the user's intent) of the ambiguous phrase 808. Then the contextual conversation assistant 804 will determine if the phrase 808 remains ambiguous 846. If it is no longer ambiguous, the contextual conversation assistant 804 may generate a conversation output 813 based on its analysis in step 850. If the phrase 808 remains ambiguous, the contextual conversation assistant 804 may request a new conversation input 860 from the user.

Thus, systems and methods to determine user intent contextually have been provided. Persons skilled in the art will appreciate that the present invention can be practiced by other than the described embodiments, which are presented for purposes of illustration rather than of limitation.

What is claimed is:

1. A contextual conversation assistant comprising:
a conversation input from a user comprising at least one phrase, said phrase comprising at least two words,
wherein the contextual conversation assistant analyzes the conversation input through, at least, a comparison of said phrase with historical data; and
when an intention of said phrase is prima facie ambiguous in view of the comparison with historical data, a self-referential internal contextual analysis of each word of the phrase comprising a comparison of each word with at least one adjacent word;
and a conversation output determined by the contextual conversation assistant wherein the conversation output is based at least in part on the contextual analysis of each word of the phrase, wherein said conversation output provides an intention of the conversation input.

2. The contextual conversation assistant of claim 1 wherein said prima facie ambiguity comprises a knowledge of an intention of the conversation input that is more likely than not to be incorrect.

3. The contextual conversation assistant of claim 1 wherein the historical data comprises at least one conversation input from a different user.

4. The contextual conversation assistant of claim 1 wherein the historical data comprises at least one older conversation input from the user.

5. The contextual conversation assistant of claim 1 wherein the contextual analysis is iterated until said phrase ceases to be prima facie ambiguous and achieves a threshold level of intention.

6. The contextual conversation assistant of claim 1 wherein the contextual analysis further comprises a comparison of each word of the phrase with both a preceding word and a subsequent word.

7. The contextual conversation assistant of claim 1 wherein the contextual analysis further comprises a comparison of each word of the phrase with all remaining words of the phrase.

8. The contextual conversation assistant of claim 1 wherein the contextual analysis further comprises a comparison of each word of the phrase with a random sampling of the conversation input.

9. The contextual conversation assistant of claim 1 wherein the conversation input comprises at least two phrases, each of said phrases comprising at least two words, and an intention of at least one of said two phrases being prima fade unambiguous and an intention of at least one of said two phrases being prima fade ambiguous.

10. The contextual conversation assistant of claim 9 wherein the contextual analysis further comprises a comparison of each word of the ambiguous phrase with the unambiguous phrase.

11. A method for analyzing an ambiguous phrase comprising:
receiving a conversation input from a user comprising at least one phrase, said phrase comprising at least two words,
comparing the phrase with historical data with known meaning;
determining context of the phrase by comparing each word of the phrase with all remaining words of the conversation input when an intention of said phrase remains prima fade ambiguous in view of the comparison with historical data; and
generating a conversation output based at least in part on the context of the phrase, wherein said conversation output provides an intention of the conversation input.

12. The method of claim 11 wherein said prima facie ambiguity comprises a knowledge of an intention of the conversation input that is more likely than not to be incorrect.

13. The method of claim 11 wherein the context of the phrase is determined by comparing each word of the phrase with a subsequent word.

14. The method of claim 11 wherein the context of the phrase is determined by comparing each word of the phrase with a preceding word.

15. The method of claim 11 wherein the context of the phrase is determined by comparing each word of the phrase with both a subsequent word and a preceding word.

16. The method of claim 11 wherein the context of the phrase is determined by comparing each word of the phrase with a random sampling of the conversation input.

17. The method of claim 11 wherein the conversation input comprises at least two phrases, each phrase comprising at least two words, and an intention of at least one of said two phrases being prima fade unambiguous and an intention of at least one of said two phrases being prima fade ambiguous and wherein the context of the ambiguous phrase is determined by comparing each word of the ambiguous phrase with the unambiguous phrase.

18. The method of claim 11 wherein the conversation output comprises a request for the user to restate the conversation input.

19. A contextual conversation assistant comprising:
a conversation input from a user comprising at least one phrase, said phrase comprising at least two words, an intention of said phrase being prima fade ambiguous,
wherein the contextual conversation assistant analyzes the conversation input through a self-referential internal contextual analysis of each word of the phrase comprising at least a comparison of each word with all remaining words of the conversation input and a comparison of each word with at least one adjacent word;
and a conversation output determined by the contextual conversation assistant wherein the conversation output is based at least in part on the contextual analysis of each word of the phrase, wherein said conversation output provides an intention of the conversation input.

20. The contextual conversation assistant of claim 19 wherein said prima facie ambiguity comprises a knowledge of an intention of the conversation input that is more likely than not to be incorrect.

21. The contextual conversation assistant of claim 19 wherein the comparison of each word of the phrase is iterated until said phrase is prima facie unambiguous.

22. The contextual conversation assistant of claim 19 wherein the contextual analysis further comprises a comparison of each word of the phrase with a random sampling of the conversation input.

23. The contextual conversation assistant of claim 19 wherein the conversation input comprises at least two phrases, each phrase comprising at least two words, and an intention of at least one of said two phrases being prima fade unambiguous and an intention of at least one of said two phrases being prima facie ambiguous and wherein the contextual analysis further comprises a comparison of each word of the ambiguous phrase with the unambiguous phrase.
